(19) United States
(12) Patent Application Publication
(10) Pub. No.: US 2026/0006547 A1
(43) Pub. Date: Jan. 1, 2026

(54) METHOD, MODEL TRAINING FUNCTION AND MODEL INFERENCE FUNCTION

(71) Applicant: NEC Corporation, Minato-ku, Tokyo (JP)

(72) Inventors: Zhe CHEN, Guíldgord (GB); Sadafuku HAYASHI, Tokyo (JP); Neeraj CUPTA, London (GB)

(73) Assignee: NEC Corporation, Minato-ku, Tokyo (JP)

(21) Appl. No.: 18/881,872

(22) PCT Filed: Aug. 1, 2023
(86) PCT No.: PCT/JP2023/028178

§ 371 Date: Jan. 7, 2025

(30) Foreign Application Priority Data
Aug. 9, 2022 (GB) 2211641.2

(51) Int. Cl. H04W 52/02; H04W 24/10; H04W 36/16

(52) U.S. Cl. CPC H04W 52/0206; H04W 24/10; H04W 36/165

(57) ABSTRACT

The method performed by a User Equipment, UE. Is disclosed, in which the method comprises the step of receiving, from an access network node, a measurement configuration for requesting information relating to expected data communication with the access network node; and transmitting, to the access network node, a measurement report including the information, wherein the information is used for outputting at least one parameter using a model for energy saving.

### TECHNICAL FIELD

The present disclosure relates to a wireless communication system and devices thereof operating according to the 3rd Generation Partnership Project (3GPP) standards or equivalents or derivatives thereof. The disclosure has particular but not exclusive relevance to network energy saving (NES) techniques in the so-called ‘5G’ or ‘New Radio’ systems (also referred to as ‘Next Generation’ systems) and similar systems.

### BACKGROUND ART

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication between the UEs and the base station is controlled using the so-called Radio Resource Control (RRC) protocol. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect Internet of Things (IoT) devices and similar Machine Type Communications (MTC) devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as MTC/IoT communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, NPL 1.

End-user communication devices are commonly referred to as User Equipment (UE) which may be operated by a human or comprise automated (MTC/IoT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). NPL 2 and NPL 3 define the following nodes, amongst others:

gNB: node providing NR user plane and control plane protocol terminations towards the UE, and connected via the NG interface to the 5G core network (5GC).

ng-eNB: node providing Evolved Universal Terrestrial Radio Access (E-UTRA) user plane and control plane protocol terminations towards the UE, and connected via the NG interface to the 5GC.

En-gNB: node providing NR user plane and control plane protocol terminations towards the UE, and acting as Secondary Node in E-UTRA-NR Dual Connectivity (EN-DC).

NG-RAN node: either a gNB or an ng-eNB.

The term base station or access network node or RAN node is used herein to refer to any such node.

The energy consumption of base stations and other similar access network nodes represents a major operational expenditure for network operators, in addition to presenting concerns with respect to the environmental impacts of operating telecommunications networks. There are various tools to save energy at the network side. For example, capacity cells (i.e. cells that are deployed for assisting certain areas in peak times) can be switched off and neighbouring cells are aware of whether the capacity cell is available or not. This function allows, for example in a deployment where capacity boosters can be distinguished from cells providing basic coverage, to optimise energy consumption enabling the possibility for an E-UTRA cell or an E-UTRA—New Radio Dual Connectivity (EN-DC) cell providing additional capacity via single or dual connectivity, to be switched off when its capacity is no longer needed and to be re-activated on a need basis. The decision is typically based on cell load information. The switch-off decision may also be taken by an Operations and Maintenance (O&M) node, or another suitable core network node.

The base station may initiate handover actions in order to off-load the cell being switched off and may indicate the reason for handover with an appropriate cause value to support the target node in taking subsequent actions, e.g. when selecting the target cell for subsequent handovers.

### CITATION LIST

### Non Patent Literature

NPL 1: ‘NGMN 5G White Paper’ V1.0 by the Next Generation Mobile Networks (NGMN) Alliance, <https://www.ngmn.org/5g-white-paper.html>
NPL 2: 3GPP TS 38.300 V16.7.0
NPL 3: 3GPP TS 37.340 V16.7.0
NPL 4: 3GPP TS 22.368 V13.1.0

### SUMMARY OF INVENTION

### Technical Problem

In general, the network can decide to switch off an entire cell if the load is not enough and UEs can be offloaded to neighbouring cells. However, this may not always be feasible, e.g. for coverage cells if no other cell is available (as the network still has to ensure service to UEs). Moreover, in some cases switching off an entire cell would result in neighbouring cells using more power (to enhance their coverage) than it would save for the cell being switched off. It would also cause some overhead signaling related to handover of UEs to a suitable neighbour cell.

An efficient implementation of network energy saving (NES) by a base station may include the following steps: 1) evaluate the current total load on the cell (optionally taking into account the load in neighbouring cells and in the core network); 2) determining an adequate NES configuration from the available configurations (for example switching off a cell of the base station); and 3) implementing the determined NES configuration. With respect to the implementation of NES, 3GPP have proposed the use of artificial intelligence (AI) and machine learning (ML), often abbreviated to AI/ML, to assist in the implementation of NES to meet the various stringent requirements of 5G networks. However, no specific implementations of NES using AI/ML have been proposed to date, and there is therefore a desire to provide such an implementation to meet these stringent requirements.

Accordingly, the present disclosure seeks to provide methods and associated apparatus that address or at least alleviate (at least some of) the above-described issues. The present disclosure is set out in the appended independent claims. Optional features are set out in the appended dependent claims.

### Solution to Problem

According to one aspect, a method performed by a User Equipment, UE, is provided. The method comprises: receiving, from an access network node, a measurement configuration for requesting information relating to expected data communication with the access network node; and transmitting, to the access network node, a measurement report including the information. The information may be used for outputting at least one parameter using a model for energy saving.

The information may include an expected next uplink or downlink data arrival time and/or a next expected data packet size.

According to another aspect, a method performed by an access network node is provided. The method comprises: receiving measurement reports from one or more user equipments, UEs, served by the access network node, each of the measurement reports including information relating to expected data communication with the access network node; and sending, to a model training function, input data including the information which is used for outputting at least one parameter using a model for energy saving.

The information may include an expected next uplink or downlink data arrival time and/or a next expected data packet size. In some example embodiments, the input data includes at least one data item from a group of: i) UE bearer context for each of the one or more UEs to which a respective UE measurement report relates; ii) location of each of the one or more UEs to which the respective UE measurement report relates; iii) load information for the access network node; iv) power consumption of a serving cell of the access network node; v) coverage cell or capacity cell indication; vi) traffic amount of each of the one or more UEs during a particular period of time; and vii) indication of model purpose. The load information may instead or also include a Physical Random Access Channel, PRACH, load. The indication of model purpose may be one of load balancing, mobility robustness and energy saving.

According to a further aspect, a method performed by a model training function of a communication network is provided. The method comprises: receiving, from at least one access network node, input data including information relating to expected data communication between a user equipment, UE, and the at least one access network node, for energy saving; training a model using the input data; and outputting a trained model to a model inference function of the communication network, for taking action for energy saving.

The information may include an expected next uplink or downlink data arrival time and/or a next expected data packet size. The input data may include at least one data item from a group of: i) UE bearer context for the UE to which a UE measurement report relates; ii) location of the UE to which a UE measurement report relates; iii) load information for each of the at least one access network node; iv) power consumption of a serving cell of each of the at least one access network node; v) coverage cell or capacity cell indication; vi) traffic amount of each UE served by each of the at least one access network node during a particular period of time; vii) indication of model purpose. The load information may include a Physical Random Access Channel, PRACH, load. The indication of model purpose may be one of load balancing, mobility robustness and energy saving.

According to another aspect, a method performed by a model inference function of a communication network is provided, the method comprising: receiving a model for outputting at least one parameter for energy saving; receiving, from at least one of a plurality of access network nodes, input data including information relating to expected data communication between a user equipment, UE, and the at least one of the plurality of access network nodes; using the input data and the model to determine energy saving predictions or decisions for the at least one of the plurality of access network nodes.

The input data may include an expected next uplink or downlink data arrival time and/or a next expected data packet size of a transmission between the at least one access network node and the UE. The input data may include at least one data item from a group of: i) UE bearer context for the UE to which a UE measurement report relates; ii) location of the UE to which a UE measurement report relates; iii) load information for each of the at least one access network node; iv) power consumption of a serving cell of each of the at least one access network node; v) coverage cell or capacity cell indication; vi) traffic amount of each UE served by each of the at least one access network node during a particular period of time; and vii) indication of model purpose. The load information may include a Physical Random Access Channel, PRACH, load.

The model inference function may be part of an access network node, and the method comprises: receiving the input data from at least one access network node which is neighbour to the access network node.

The method may further comprise sending an energy prediction or decision notification to the at least one access network node, the notification including at least one data item from a group of: i) an activation or deactivation pattern; ii) cell or BWP or Beam or Antenna port power pattern; iii) an energy saving level indication; iv) a power state indication; v) a relative power indication; vi) transition time indication which indicates when the power should be adjusted; vii) transition energy which represents the energy value to which the serving cell can be reduced; viii) handover decision parameters.

The activation or deactivation pattern may define a period and/or slot when a cell or a Bandwidth Part, BWP, or a Synchronisation Signal Block, SSB, or a Channel state Information Reference Signal, CSI-RS, or a Beam or an Antenna port of the at least one access network node is activated or deactivated. The power state indication may indicate a sleep or non-sleep state for a serving cell of the at least one access network node. The handover decision parameters include a measurement event configuration for at least one UE of the at least one access network node and/or a handover trigger time upon reception of a measurement event.

In some example embodiments, the power pattern defines, for a period and slot, how the power of each cell or BWP or Beam or Antenna port of the at least one access network node is configured.

According to another aspect, there is provided a User Equipment, UE, comprising: means for receiving, from an access network node, a measurement configuration for requesting information relating to expected data communication with the access network node; and means for transmitting, to the access network node, a measurement report including the information. The information may be used for outputting at least one parameter using a model for energy saving.

According to another aspect, there is provided an access network node comprising: means for receiving measurement reports from one or more user equipments, UEs, served by the access network node, each of the measurement reports including information relating to expected data communication with the access network node; and means for sending, to a model training function, input data including the information which is used for outputting at least one parameter using a model for energy saving.

According to a further aspect, there is provided a model training function of a communication network, the model training function comprising: means for receiving, from at least one access network node, input data including information relating to expected data communication between a user equipment, UE, and the at least one access network node, for energy saving; means for training a model using the input data; and means for outputting a trained model to a model inference function of the communication network, for taking action for the energy saving.

According to a further aspect, there is provided a model inference function of a communication network, the model inference function comprising: means for receiving a model for outputting at least one parameter for energy saving; means for receiving, from at least one of a plurality of access network nodes, input data including information relating to expected data communication between a user equipment, UE, and the at least one of the plurality of access network nodes; and means for using the input data and the model to determine energy saving predictions or decisions for the at least one of the plurality of access network nodes.

Each feature disclosed in this specification (which term includes the claims) and/or shown in the drawings may be incorporated in the disclosure independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Example embodiments of the disclosure will now be described, by way of examples, with reference to the accompanying drawings in which:

FIG. 1 illustrates schematically a mobile (cellular or wireless) telecommunication system to which example embodiments of the disclosure may be applied;

FIG. 2 is a schematic block diagram of a mobile device forming part of the system shown in FIG. 1;

FIG. 3 is a schematic block diagram of an access network node (e.g. base station) forming part of the system shown in FIG. 1;

FIG. 4 is a schematic block diagram of a core network node forming part of the system shown in FIG. 1;

FIG. 5 is a schematic diagram illustrating the interactions between nodes of a system, when using Artificial Intelligence/Machine Learning;

FIG. 6 is a schematic signaling (timing) diagram illustrating the interactions between nodes of the telecommunication system to save energy in the system according to a first example embodiment; and

FIG. 7 is a schematic signaling (timing) diagram illustrating the interactions between nodes of the telecommunication system to save energy in the system according to a second example embodiment.

### DESCRIPTION OF EXAMPLE EMBODIMENTS

### Overview

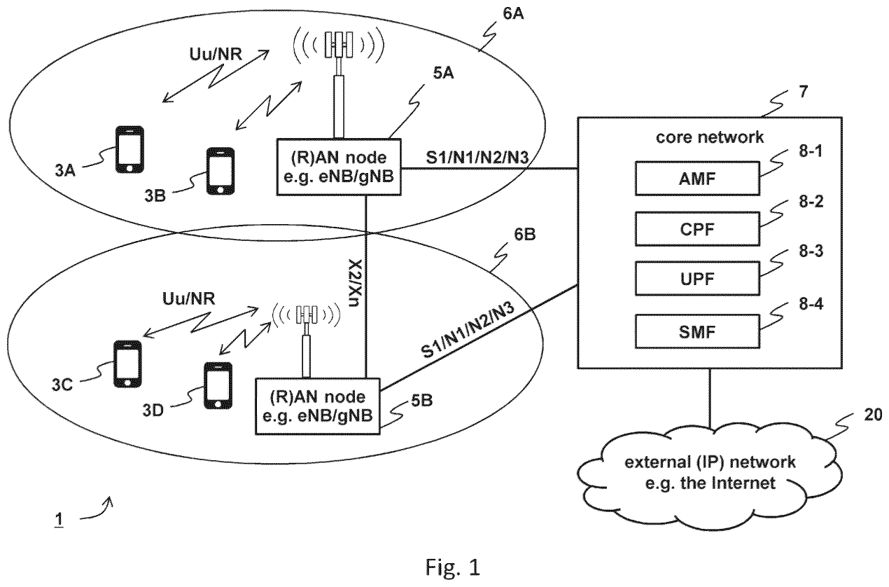

FIG. 1 illustrates schematically a mobile (cellular or wireless) telecommunication system 1 to which example embodiments of the disclosure may be applied.

In this system 1, users of mobile devices 3 (UEs) can communicate with each other and other users via base stations 5 (and other access network nodes) and a core network 7 using an appropriate 3GPP radio access technology (RAT), for example, an Evolved Universal Terrestrial Radio Access (E-UTRA) and/or a 5G RAT. It will be appreciated that a number of base stations 5 form a (radio) access network or (R)AN. As those skilled in the art will appreciate, whilst four mobile devices 3A, 3B, 3C and 3D and two base stations 5A and 5B are shown in FIG. 1 for illustration purposes, the system, when implemented, will typically include other base stations/(R)AN nodes and mobile devices (UEs).

Each base station 5 controls one or more associated cells 6 (either directly or via other nodes such as home base stations, relays, remote radio heads, distributed units, and/or the like). A base station 5 that supports Next Generation/5G protocols may be referred to as a ‘gNB’. It will be appreciated that some base stations 5 may be configured to support both 4G and 5G, and/or any other 3GPP or non-3GPP communication protocols.

The mobile device 3 and its serving base station 5 are connected via an appropriate air interface (for example the so-called ‘NR’ air interface, the ‘Uu’ interface, and/or the like). Neighbouring base stations 5 may be connected to each other via an appropriate base station to base station interface (such as the so-called ‘Xn’ interface, the ‘X2’ interface, and/or the like). The base stations 5 are also connected to the core network nodes via an appropriate interface (such as the so-called ‘NG-U’ interface (for user-plane), the so-called ‘NG-C’ interface (for control-plane), and/or the like).

The core network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the core network 7 of a ‘Next Generation’/5G system will include user plane entities and control plane entities, such as one or more control plane functions (CPFs) 8-2 and one or more user plane functions (UPFs) 8-3. The core network 7 will also include the so-called Access and Mobility Management Function (AMF) 8-1 in 5G, or the Mobility Management Entity (MME) in 4G, that is responsible for handling connection and mobility management tasks for the mobile devices 3. The Session Management Function (SMF) 8-4 that is responsible for handling communication sessions for the mobile devices 3 such as session establishment, modification and release. The Operations, Administration and Maintenance (OAM) function 8-5 may be implemented in software in one or more 5G CN nodes. The core network 7 is coupled (via the UPF 11) to a data network 20, such as the Internet or a similar Internet Protocol (IP) based network.

### User Equipment (UE)

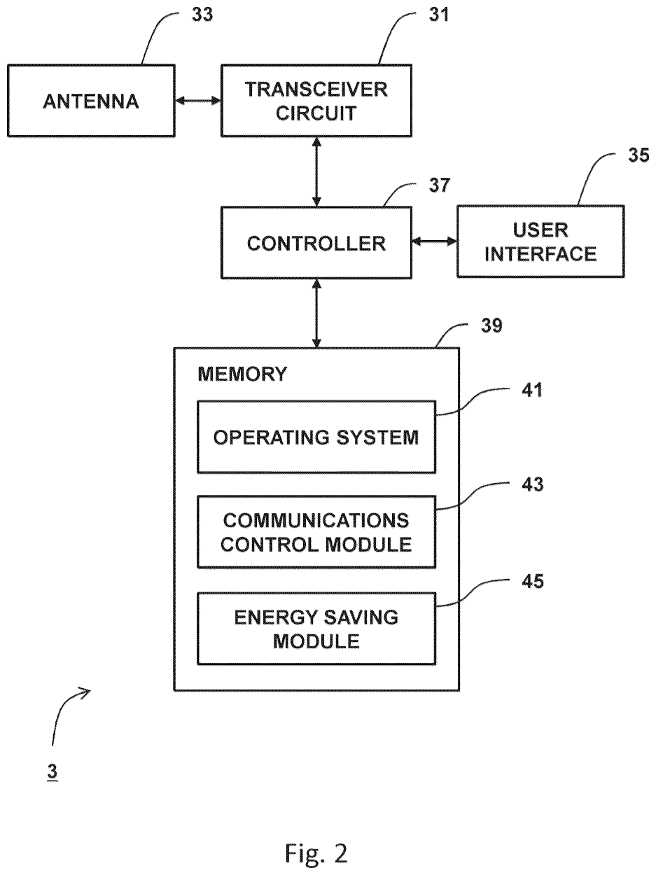

FIG. 2 is a block diagram illustrating the main components of a mobile device (UE) 3 shown in FIG. 1. As shown, the UE 3 includes a transceiver circuit 31 which is operable to transmit signals to and to receive signals from at least one connected node via one or more antennas 33. Although not necessarily shown in FIG. 2, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, and an energy saving module 45.

The communications control module 43 is responsible for handling (generating/sending/receiving) signaling messages and uplink/downlink data packets between the UE 3 and other nodes, including (R)AN nodes 5 and core network nodes. The signaling may comprise control signaling, (e.g. via system information or RRC) related to the energy saving operation. It will be appreciated that the communications control module 43 may include a number of sub-modules (‘layers’ or ‘entities’) to support specific functionalities. For example, the communications control module 43 may include a PHY sub-module, a MAC sub-module, an RLC sub-module, a PDCP sub-module, an SDAP sub-module, an IP sub-module, an RRC sub-module, etc.

The energy saving module 45 is responsible for operations relating to energy saving (by the UE 3 itself and/or by network nodes such as the access network node/base station 5). Energy saving by the UE itself is typically achieved by turning off certain components (e.g. the transceiver circuit 31) for certain periods. As will be explained in more detail below, in the following example embodiments, the UE 3 can assist the network perform energy saving by taking various actions that help the network to obtain a more accurate picture of the actual load currently on the network.

### Access Network Node (Base Station)

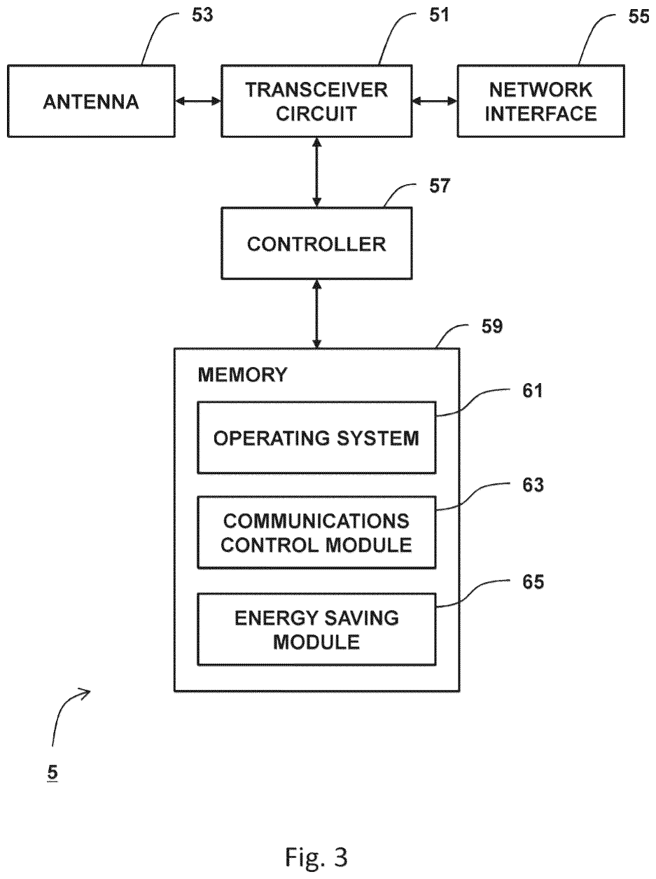

FIG. 3 is a block diagram illustrating the main components of the base station 5 (or a similar access network node) shown in FIG. 1. As shown, the base station 5 includes a transceiver circuit 51 which is operable to transmit signals to and to receive signals from at least one connected UE 3 via one or more antennas 53 and to transmit signals to and to receive signals from other network nodes (either directly or indirectly) via a network interface 55. The network interface 55 typically includes an appropriate base station to base station interface (such as an X2/Xn interface), and an appropriate base station to core network interface (such as an S1/N1/N2/N3 interface). A controller 57 controls the operation of the base station 5 in accordance with software stored in a memory 59. The software may be pre-installed in the memory 59 and/or may be downloaded via the telecommunication network 1 or from a removable data storage device (RMD), for example. The software includes, among other things, an operating system 61, a communications control module 63, and an energy saving module 65.

The communications control module 63 is responsible for handling (generating/sending/receiving) signaling between the base station 5 and other nodes, such as the UE 3 and the core network nodes. The signaling may comprise control signaling (e.g. via system information or RRC) related to the energy saving operation. It will be appreciated that the communications control module 63 may include a number of sub-modules (‘layers’ or ‘entities’) to support specific functionalities. For example, the communications control module 63 may include a PHY sub-module, a MAC sub-module, an RLC sub-module, a PDCP sub-module, an SDAP sub-module, an IP sub-module, an RRC sub-module, etc.

The energy saving module 65 is responsible for operations relating to energy saving (by the UE 3 and/or by the access network node/base station 5 itself). Energy saving is typically achieved by turning off certain components (e.g. the transceiver circuit 51) for certain periods.

### Core Network Function

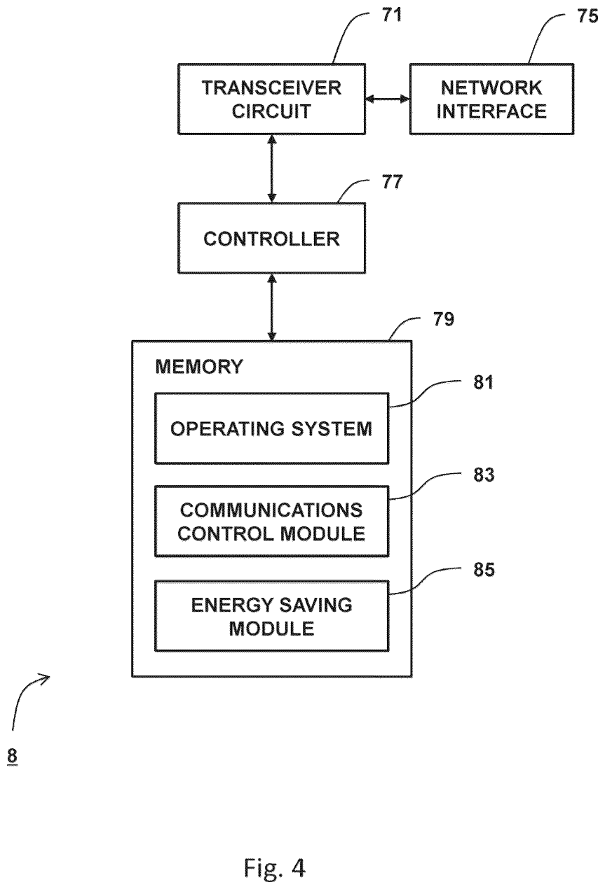

FIG. 4 is a block diagram illustrating the main components of a generic core network node or function 8, such as the AMF 8-1, CPF 8-2, the UPF 8-3, the SMF 8-4 or the OAM 8-5 shown in FIG. 1. As shown, the core network function includes a transceiver circuit 71 which is operable to transmit signals to and to receive signals from other nodes (including the UE 3, the base station 5, and other core network nodes) via a network interface 75. A controller 77 controls the operation of the core network function in accordance with software stored in a memory 79. The software may be pre-installed in the memory 79 and/or may be downloaded via the telecommunication network 1 or from a removable data storage device (RMD), for example. The software includes, among other things, an operating system 81, a communications control module 83, and an energy saving module 85 (which may be optional).

The communications control module 83 is responsible for handling (generating/sending/receiving) signaling between the core network function and other nodes, such as the UE 3, the base station 5, and other core network nodes. The signaling may include for example a UE context/UE capability indication of a UE 3 related to energy saving.

If present, the energy saving module 85 is responsible for operations relating to energy saving (e.g. by the UE 3 and/or by the access network node/base station 5).

### Artificial Intelligence (AI)/Machine Learning (ML)

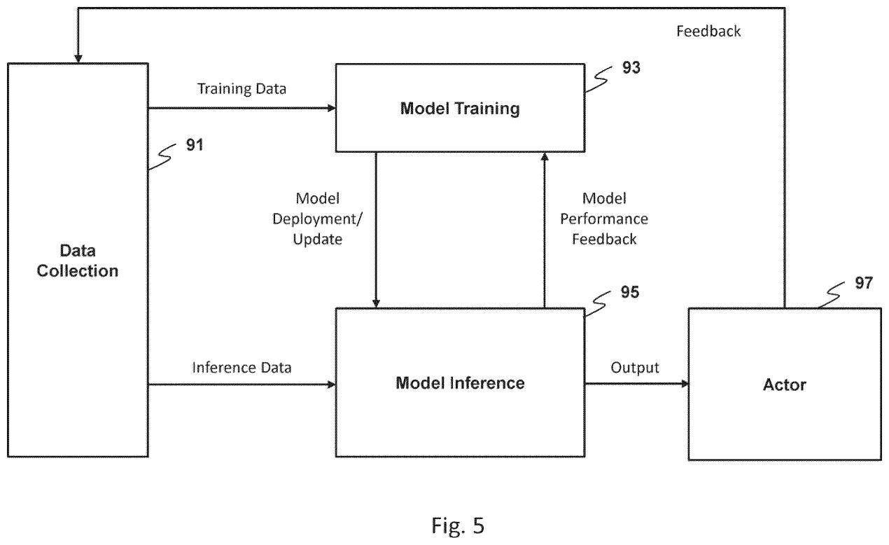

3GPP have proposed a functional framework in respect of AI/ML, and how various entities of the telecommunications system are to interact with one another in the context of this framework. In this regard, reference is now made to FIG. 5, which illustrates these entities.

The entities involved relate to a data collection function 91, a model training function 93, a model inference function 95, and actor 97. The data collection function 91 provides input data (training data) to the model training function 93 and the model inference function 95. The model training function 93 performs the ML model training, validation, and testing which may generate model performance metrics as part of a model testing procedure. The model inference function 95 provides AI/ML model inference output (e.g., predictions or decisions), and the actor 97 is a function or node that receives the output from the model inference function 95 and triggers or performs corresponding actions (e.g. an (radio) access network node which increases/reduces its transmit power to effect network energy saving).

Terms referred to by 3GPP in the context of this framework include:

AI/ML Model: A data driven algorithm by applying machine learning techniques that generates a set of outputs including predicted information and/or decision parameters, based on a set of inputs

AI/ML Training: An online or offline process to train an AI/ML model by learning features and patterns that best present data and get the trained AI/ML model for inference.

AI/ML Inference: A process of using a trained AI/ML model to make a prediction or guide the decision based on collected data and AI/ML model.

Training Data: Data needed as input for the AI/ML Model Training function.

Inference Data: Data needed as input for the AI/ML Model Inference function.

Model Deployment/Update: Used to initially deploy a trained, validated, and tested AI/ML model to the Model Inference function or to deliver an updated model to the Model Inference function.

### DETAILED DESCRIPTION

The following is a description of how network loads may be determined, using AI/ML, thereby allowing the network to make better network energy saving decisions within the system 1 shown in FIG. 1.

A first example embodiment to determine network energy saving configurations and take appropriate further actions locates a model inference function 95 within a base station 5, such as within a (R)AN node, e.g. a gNB, or within a control unit of a gNB (gNB-CU). Beneficially, locating the model inference function 95 at the base station 5 allows rapid energy saving decisions to be taken across cells as appropriate.

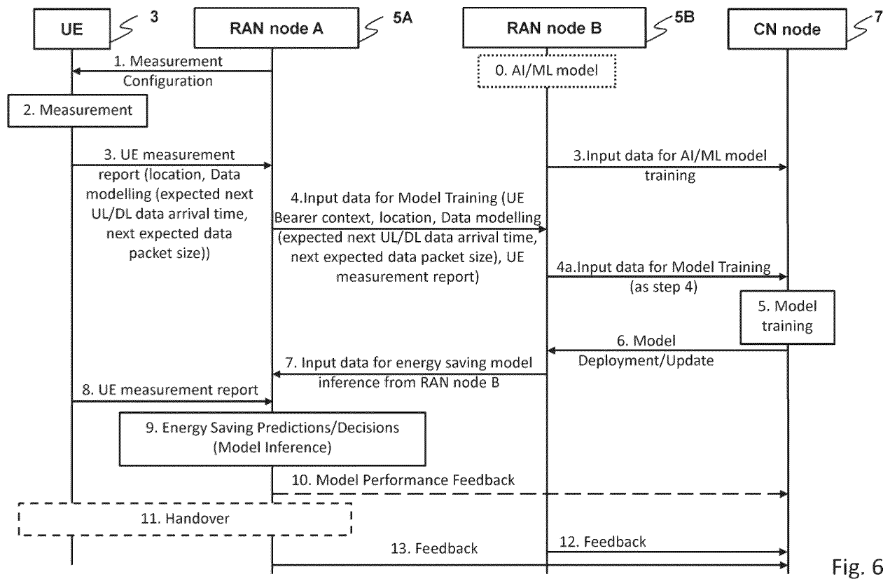

A more detailed description of the first example embodiment will now be described with reference to the signaling diagram shown in FIG. 6.

In overview, FIG. 6 illustrates the communications which occur between a UE 3, a base station (RAN node 5A) serving the UE 3, another neighbouring base station (RAN node 5B), and a core network 7 node (such as the OAM 8-5 function of the core network 7), in the context of network energy saving using AI/ML. Before considering this signaling in more detail, step 0 indicates that RAN node 5B may optionally comprise its own AI/ML model, which can provide RAN node 5A with useful input information (discussed in more detail below), such as its predicted resource status, etc., as needed during the network energy saving procedure.

In step 1, RAN node 5A signals a measurement configuration request to the UE 3 that the UE 3 is to report measurement and/or location information (e.g., radio resource management (RRM) measurements, reference signal received power (RSRP), reference signal received quality (RSRQ), signal to interference plus noise ratio (SINR) of the UE's serving cell and of neighbouring cells, minimisation of drive tests (MDT) measurements data, the UE's velocity information, the UE's positional information (e.g. GPS data), etc.). Whilst only one UE 3 is referred to in FIG. 6 and the associated description which follows, it will be appreciated that, in practice, multiple UEs will be signaled by the RAN node 5A in step 1 and that the RAN node 5A will receive corresponding measurement reports from each of these UEs. Moreover, the RAN node 5A may be configured to operate more than one cell, and therefore the RAN node 5A may make such requests across the cells it operates.

Then, in step 2, the UE 3 collects the requested measurement and/or location information and reports, via a UE measurement report message, the collected information to RAN node 5A in step 3. In addition to the above mentioned parameters, the UE may also report information relating to expected data communication. For example, its expected next uplink/downlink (UL/DL) data arrival time, and/or its next expected data packet size (e.g., the UE may model which data it expects to receive/when it expects to receive it via data modelling).

The RAN node 5A then signals, in step 4, one or more received UE measurement reports together with its own data as input data for training the

AI/ML model. This training is performed in the core network 7 (e.g. at the core network's OAM function 8-5). The information sent from the RAN node 5A to the core network node 7 may include:
The UE 3's:
bearer context (and its 5G quality of service identifier (5GQI);
measurement report, including the data modelling information determined by UE 3 (e.g. the UE's next expected next UL/DL data arrival time, and/or its next expected data packet size);
The RAN node 5A's:
load information, including the RAN node's physical random access channel (PRACH) load;
the power consumption at a serving cell operated by the RAN node 5A;
whether or not the cell operated by the RAN node 5A is a coverage cell or a capacity cell;
the amount of traffic in the RAN node's serving cell during a given period of time; and
an indication of AI/ML purpose (e.g. for (network) energy saving, load balancing, mobility robustness, or the like).

Furthermore, RAN node 5B may also send its own input data, broadly corresponding to the above input data, for model training to the core network node 7 in step 4a. As those skilled in the art will appreciate, the data collection and reporting to the core network node 7 in this way is not a “one off” activity. The UEs 3 being served by the base stations 5 will change over time as will their data requirements. Therefore, either, or both, of RAN nodes 5A and 5B will keep sending their respective input data to the core network 7 at regular (or irregular) intervals. In this way, the core network node 7 can retrain the model to reflect the changing traffic conditions within the network. Over time as the network provides feedback about the predictions made using the model, the model will become better calibrated to the network behaviour, beneficially resulting in a model which provides predictions/decisions with greater accuracy.

As illustrated in step 5, the AI/ML Model Training function 93, located in the core network 7, processes the input data received in steps 4 and 4a to train the AI/ML model. The AI/ML model is trained using conventional machine learning training techniques that will not be described here.

The core network 7, having trained the AI/ML model, updates the AI/ML model locally stored at the RAN node 5A (or deploys the AI/ML model to the RAN node 5A, if a model is not locally stored by RAN node 5A) in step 6. The AI/ML model may also be deployed to or updated in RAN node 5B.

Then, in step 7, RAN node 5B sends its latest input data to RAN node 5A for model inference of AI/ML-based network energy saving. RAN node 5B sends this information to RAN node 5A at regular intervals or whenever RAN node 5B detects that its loading has changed sufficiently that it might result in a different NES decision being generated by the model inference.

In step 8, the UE 3 sends one or more updated UE measurement reports to RAN node 5A. Then, in step 9, based on the input received from RAN node 5B in step 7 and the one or more UE measurement reports received in step 8, RAN node 5A's model inference function 95 generates one or more model inference outputs (e.g., network energy saving strategy predictions and/or decisions, handover strategy predictions and/or decisions, etc).

Optionally, in step 10, RAN node 5A may send model performance feedback to the core network 7, if appropriate.

In step 11, RAN node 5A executes network energy saving actions (or handover strategy predictions) according to the output generated by model inference function 95 in step 9, and if the output is handover strategy, RAN node 5A may select the most appropriate target cell for each UE before it performs handover.

Then, in steps 12 and 13, each RAN node 5B, 5A respectively sends to the core network 7 feedback information in respect of the change effected by the RAN node 5A in response to the (updated) model received from the core network 7.

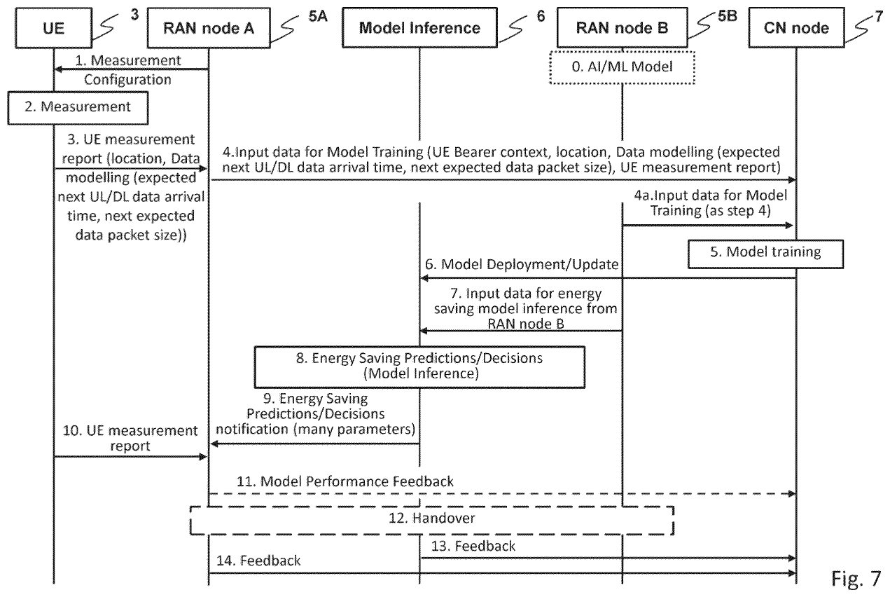

In the example embodiment described above with reference to FIG. 6, the model inference function 95 was located in a RAN node 5 and the training model was located in the core network. In the following second example embodiment, described with reference to FIG. 7, the model inference function is instead located in a separate node (rather than in the RAN node 5A and/or in the RAN node 5B). In this example embodiment, as in the previous example embodiment, the model training function 93 is located in the core network 7.

Referring now to FIG. 7, steps 0 to 5 of this example embodiment are substantially the same as steps 0 to 5 of the first example embodiment illustrated in FIG. 6, and therefore will not be described again.

Continuing at step 6, the core network 7 deploys the trained model to the model inference node 6 (or it updates the model if a model has already been deployed).

Once deployed/updated, RAN node 5B send its latest input data to the model inference node 6 for model inference of AI/ML-based network energy saving in step 7.

Then, in step 8, based on the input received from RAN node 5B in step 7, the model inference node 6 generates one or more model inference outputs (e.g., network energy saving strategy predictions and/or decisions, handover strategy predictions and/or decisions, etc.), and provides the outputted predictions/decisions in step 9 to RAN node 5A. Such output may include one or more of the following parameters for RAN node 5A to implement locally:
cell/bandwidth part (BWP)/Beam/Antenna port activation/de-activation pattern which can indicate a specific time in a day/week/month that the cell/BWP/Beam/antenna port is activated or deactivated;
cell/BWP/Beam Antenna port power pattern;
low/medium/high energy saving level;
power state (including sleep/non-sleep mode for a serving cell operated by the RAN node 5A, where the sleep mode refers to the dormancy state of the serving cell);
Relative power indication (which indicates a value to which the cell power is adjusted (this may take a specific value or may be represented by power levels set to “high”, “low”, or “in-between”, etc.);
Transition time (which indicates when, temporally, the power should be adjusted);
Transition energy (which represents the energy value to which the serving cell can be reduced); and
handover decision parameters (measurement event configuration, handover trigger time upon reception of each measurement event to each neighbour cell)

For instance, the Cell/BWP/SSB/CSI-RS/Beam activation/de-activation pattern may define the period and slot when cell/BWP/Beam is activated or de-activated, e.g. as presented in the table below:

| Cell/BWP/SSB/CSI-RS/Beam | Time slot | Action |
|---|---|---|
| Cell1/BWP1/SSB1 | 200 ms | Activation |
| Cell2/BWP2/SSB2 | 500 ms | Deactivation |

As a further example, a cell in a business district of a city may be activated at 7 am and deactivated at 7 pm from Monday to Friday and kept deactivated Saturday and Sunday. Similarly, the Cell/BWP/SSB/CSI-RS/Beam power pattern may define the period and slot of how the power of each cell/BWP/Beam is configured, e.g. as presented in the table below:

| Cell/BWP/SSB/CSI-RS/Beam | Time slot | Action |
|---|---|---|
| Cell1/BWP1/SSB1 | 200 ms | −25 dbm |
| Cell2/BWP2/SSB2 | 500 ms | −23 dbm |

As represented in step 10, the UE 3 keeps sending one or more updated UE measurement reports to RAN node 5A and, optionally, in step 11, RAN node 5A may send model performance feedback to the core network 7, if appropriate.

In step 12, RAN node 5A executes network energy saving actions according to the output of the model inference node 6 generated in step 8, and if the output is handover strategy, RAN node 5A may select the most appropriate target cell for each UE 3 (e.g. a cell operated by RAN node 5B) before it performs handover.

Then, in steps 13 and 14, each RAN node 5B, 5A respectively sends to the core network 7 feedback information in respect of the change effected by the RAN node 5A in response to the output received from the model inference node 6.

### Modifications and Alternatives

Detailed example embodiments have been described above. As those skilled in the art will appreciate, a number of modifications and alternatives can be made to the above example embodiments whilst still benefiting from the disclosures embodied therein. By way of illustration only a number of these alternatives and modifications will now be described.

It will be appreciated that the above example embodiments may be applied to both 5G New Radio (5G NR) and LTE systems (E-UTRAN). The above example embodiments may also be applied to future systems (beyond 5G, 6G, etc.).

The next-generation mobile networks support diversified service requirements, which have been classified into three categories by the International Telecommunication Union (ITU): Enhanced Mobile Broadband (eMBB); Ultra-Reliable and Low-Latency Communications (URLLC); and Massive Machine Type Communications (mMTC). eMBB aims to provide enhanced support of conventional mobile broadband, with focus on services requiring large and guaranteed bandwidth such as High Definition (HD) video, Virtual Reality (VR), and Augmented Reality (AR). URLLC is a requirement for critical applications such as automated driving and factory automation, which require guaranteed access within a very short time. MMTC needs to support massive number of connected devices such as smart metering and environment monitoring but can usually tolerate certain access delay. It will be appreciated that some of these applications may have relatively lenient Quality of Service/Quality of Experience (QoS/QoE) requirements, while some applications may have relatively stringent QoS/QoE requirements (e.g. high bandwidth and/or low latency).

In the above description, the UE, the access network node (base station), and the core network node are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above example embodiments, a number of software modules were described. As those skilled in the art will appreciate, the software modules may be provided in compiled or un-compiled form and may be supplied to the UE, the access network node (base station), and the core network node as a signal over a computer network, or on a recording medium. Further, the functionality performed by part or all of this software may be performed using one or more dedicated hardware circuits. However, the use of software modules is preferred as it facilitates the updating of the UE, the access network node, and the core network node in order to update their functionalities.

It will be appreciated that the functionality of a base station (referred to as a ‘distributed’ base station or gNB) may be split between one or more distributed units (DUs) and a central unit (CU) with a CU typically performing higher level functions and communication with the next generation core and with the DU performing lower level functions and communication over an air interface with UEs in the vicinity (i.e. in a cell operated by the gNB). A distributed gNB includes the following functional units:

gNB Central Unit (gNB-CU): a logical node hosting Radio Resource Control (RRC), Service Data Adaptation Protocol (SDAP) and Packet Data Convergence Protocol (PDCP) layers of the gNB (or RRC and PDCP layers of an en-gNB) that controls the operation of one or more gNB-DUs. The gNB-CU terminates the so-called F1 interface connected with the gNB-DU.

gNB Distributed Unit (gNB-DU): a logical node hosting Radio Link Control (RLC), Medium Access Control (MAC) and Physical (PHY) layers of the gNB or en-gNB, and its operation is partly controlled by gNB-CU. One gNB-DU supports one or multiple cells. One cell is supported by only one gNB-DU. The gNB-DU terminates the F1 interface connected with the gNB-CU.

gNB-CU-Control Plane (gNB-CU-CP): a logical node hosting the RRC and the control plane part of the PDCP protocol of the gNB-CU for an en-gNB or a gNB. The gNB-CU-CP terminates the so-called E1 interface connected with the gNB-CU-UP and the F1-C (F1 control plane) interface connected with the gNB-DU.

gNB-CU-User Plane (gNB-CU-UP): a logical node hosting the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U (F1 user plane) interface connected with the gNB-DU.

It will be appreciated that when a distributed base station or a similar control plane-user plane (CP-UP) split is employed, the base station may be split into separate control-plane and user-plane entities, each of which may include an associated transceiver circuit, antenna, network interface, controller, memory, operating system, and communications control module. When the base station comprises a distributed base station, the network interface (reference numeral 55 in FIG. 3) also includes an E1 interface and an F1 interface (F1-C for the control plane and F1-U for the user plane) to communicate signals between respective functions of the distributed base station. In this case, the communications control module is also responsible for communications (generating, sending, and receiving signaling messages) between the control-plane and user-plane parts of the base station. It will be appreciated that when a distributed base station is used there is no need to involve both the control-plane and user-plane parts for pre-emption of communication resources as described in the above example embodiments. It will be appreciated that pre-emption may be handled by the user-plane part of the base station without involving the control-plane part (or vice versa).

The above example embodiments are also applicable to ‘non-mobile’ or generally stationary user equipment. The above described mobile device may comprise an MTC/IoT device and/or the like.

The User Equipment (or “UE”, “mobile station”, “mobile device” or “wireless device”) in the present disclosure is an entity connected to a network via a wireless interface.

It should be noted that the present disclosure is not limited to a dedicated communication device, and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; (motor) vehicles; motor cycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to ‘internet of things’ (IoT), using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table (source: NPL 4, Annex B, the contents of which are incorporated herein by reference). This list is not exhaustive and is intended to be indicative of some examples of machine type communication applications.

| Service Area | MTC applications |
|---|---|
| Security | Surveillance systems |
| | Backup for landline |
| | Control of physical access |
| | (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/Control | Sensors |
| | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an Mobile Virtual Network Operator (MVNO) service, an emergency radio communication system, a Private Branch exchange (PBX) system, a PHS/Digital Cordless Telecommunications system, a Point of sale (POS) system, an advertise calling system, a Multimedia Broadcast and Multicast Service (MBMS), a Vehicle to Everything (V2X) system, a train radio system, a location related service, a Disaster/Emergency Wireless Communication Service, a community service, a video streaming service, a femto cell application service, a Voice over LTE (VoLTE) service, a charging service, a radio on demand service, a roaming service, an activity monitoring service, a telecom carrier/communication NW selection service, a functional restriction service, a Proof of Concept (PoC) service, a personal information management service, an ad-hoc network/Delay Tolerant Networking (DTN) service, etc.

Further, the above-described UE categories are merely examples of applications of the technical ideas and example embodiments described in the present document. Needless to say, these technical ideas and example embodiments are not limited to the above-described UE and various modifications can be made thereto.

Various other modifications will be apparent to those skilled in the art and will not be described in further detail here.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

### Supplementary Note A1

A method performed by a User Equipment, UE, the method comprising:
receiving a measurement configuration from an access network node; and
transmitting a measurement report to the access network node, the measurement report including information relating to expected data communication with the access network node.

### Supplementary Note A2

A method performed by an access network node, the method comprising:
receiving one or more user equipment, UE, measurement reports from one or more UEs served by the access network node, the UE measurement report including information relating to expected data communication with the access network node; and
sending input data to a model training function, the input data including the information.

### Supplementary Note A3

A method performed by a model training function of a communication network, the method comprising:
receiving input data from at least one of a plurality of access network nodes, the input data including information relating to expected data communication between a User Equipment and the at least one access network node;
training a model using the input data and outputting the trained model to a model inference function of the communication network.

### Supplementary Note A4

A method performed by a model inference function of a communication network, the method comprising:
receiving a model trained using the method of Supplementary Note A3;
receiving updated input data from at least one of a plurality of access network nodes, the updated input data including information relating to expected data communication between a User Equipment and the at least one access network node;
using the received updated input data and the model to determine energy saving predictions or decisions for at least one access network node.

### Supplementary Note A5

A User Equipment, UE, comprising:
means for receiving a measurement configuration from an access network node; and
means for transmitting a measurement report to the access network node, the measurement report including information relating to expected data communication with the access network node.

### Supplementary Note A6

An access network node comprising:
means for receiving one or more user equipment, UE, measurement reports from one or more UEs served by the access network node, the UE measurement report including information relating to expected data communication with the access network node; and
means for sending input data to a model training function, the input data including the information.

### Supplementary Note A7

A model training function of a communication network, the model training function comprising:
means for receiving input data from at least one of a plurality of access network nodes, the input data including information relating to expected data communication between a User Equipment and the at least one access network node;
means for training a model using the input data and outputting the trained model to a model inference function of the communication network.

### Supplementary Note A8

A model inference function of a communication network, the model inference function comprising:
means for receiving a model trained using the method of Supplementary Note A3;
means for receiving updated input data from at least one of a plurality of access network nodes, the updated input data including information relating to expected data communication between a User Equipment and the at least one access network node; and
means for using the received updated input data and the model to determine energy saving predictions or decisions for at least one access network node.

### Supplementary Note B1

A method performed by a user equipment, UE, the method comprising:
receiving, from an access network node, a measurement configuration for requesting information relating to expected data communication with the access network node; and
transmitting, to the access network node, a measurement report including the information, wherein
the information is used for outputting at least one parameter using a model for energy saving.

### Supplementary Note B2

The method of Supplementary Note B1, wherein the information includes an expected next uplink or downlink data arrival time and/or a next expected data packet size.

### Supplementary Note B3

A method performed by an access network node, the method comprising:
receiving measurement reports from one or more user equipments, UEs, served by the access network node, each of the measurement reports including information relating to expected data communication with the access network node; and
sending, to a model training function, input data including the information which is used for outputting at least one parameter using a model for energy saving.

### Supplementary Note B4

The method according to Supplementary Note B3, wherein the information includes an expected next uplink or downlink data arrival time and/or a next expected data packet size.

### Supplementary Note B5

The method according to Supplementary Note B3 or B4, wherein the input data includes at least one data item from a group of:
i) UE bearer context for each of the one or more UEs to which a respective UE measurement report relates;
ii) location of each of the one or more UEs to which the respective UE measurement report relates;
iii) load information for the access network node;
iv) power consumption of a serving cell of the access network node;
v) coverage cell or capacity cell indication;
vi) traffic amount of each of the one or more UEs during a particular period of time; and
vii) indication of model purpose.

### Supplementary Note B6

The method according to Supplementary Note B5, wherein the load information includes a Physical Random Access Channel, PRACH, load.

### Supplementary Note B7

The method of Supplementary Note B5 or B6, wherein the indication of model purpose is one of load balancing, mobility robustness and energy saving.

### Supplementary Note B8

A method performed by a model training function of a communication network, the method comprising:
receiving, from at least one access network node, input data including information relating to expected data communication between a user equipment, UE, and the at least one access network node, for energy saving;
training a model using the input data; and
outputting a trained model to a model inference function of the communication network, for taking action for energy saving.

### Supplementary Note B9

The method of Supplementary Note B8, wherein the information includes an expected next uplink or downlink data arrival time and/or a next expected data packet size.

### Supplementary Note B10

The method of Supplementary Note B8 or B9, wherein the input data includes at least one data item from a group of:
i) UE bearer context for the UE to which a UE measurement report relates;
ii) location of the UE to which a UE measurement report relates;
iii) load information for each of the at least one access network node;
iv) power consumption of a serving cell of each of the at least one access network node;
v) coverage cell or capacity cell indication;
vi) traffic amount of each UE served by each of the at least one access network node during a particular period of time;
vii) indication of model purpose.

### Supplementary Note B11

The method according to Supplementary Note B10, wherein the load information includes a Physical Random Access Channel, PRACH, load.

### Supplementary Note B12

The method of Supplementary Note B10 or B11, wherein the indication of model purpose is one of load balancing, mobility robustness and energy saving.

### Supplementary Note B13

A method performed by a model inference function of a communication network, the method comprising:
receiving a model for outputting at least one parameter for energy saving;
receiving, from at least one of a plurality of access network nodes, input data including information relating to expected data communication between a user equipment, UE, and the at least one of the plurality of access network nodes;
using the input data and the model to determine energy saving predictions or decisions for the at least one of the plurality of access network nodes.

### Supplementary Note B14

The method of Supplementary Note B13, wherein the input data includes an expected next uplink or downlink data arrival time and/or a next expected data packet size of a transmission between the at least one access network node and the UE.

### Supplementary Note B15

The method of Supplementary Note B13 or B14, wherein the input data includes at least one data item from a group of:
i) UE bearer context for the UE to which a UE measurement report relates;
ii) location of the UE to which a UE measurement report relates;
iii) load information for each of the at least one access network node;
iv) power consumption of a serving cell of each of the at least one access network node;
v) coverage cell or capacity cell indication;
vi) traffic amount of each UE served by each of the at least one access network node during a particular period of time; and
vii) indication of model purpose.

### Supplementary Note B16

The method according to Supplementary Note B15, wherein the load information includes a Physical Random Access Channel, PRACH, load.

### Supplementary Note B17

The method according to any one of Supplementary Notes B13 to B16, wherein
the model inference function is part of an access network node, and the method comprises:
receiving the input data from at least one access network node which is neighbour to the access network node.

### Supplementary Note B18

The method according to any one of Supplementary Notes B13 to B16, further comprising sending an energy prediction or decision notification to the at least one access network node, the notification including at least one data item from a group of:
i) an activation or deactivation pattern;
ii) cell or BWP or Beam or Antenna port power pattern;
iii) an energy saving level indication;
iv) a power state indication;
v) a relative power indication;
vi) transition time indication which indicates when the power should be adjusted;
vii) transition energy which represents the energy value to which the serving cell can be reduced;
viii) handover decision parameters.

### Supplementary Note B19

The method of Supplementary Note B18, wherein the activation or deactivation pattern defines a period and/or slot when a cell or a Bandwidth Part, BWP, or a Synchronisation Signal Block, SSB, or a Channel state Information Reference Signal, CSI-RS, or a Beam or an Antenna port of the at least one access network node is activated or deactivated.

### Supplementary Note B20

The method of Supplementary Note B18 or B19, wherein the power pattern defines, for a period and slot, how the power of each cell or BWP or Beam or Antenna port of the at least one access network node is configured.

### Supplementary Note B21

The method of any one of Supplementary Notes B18 to B20, wherein the power state indication indicates a sleep or non-sleep state for a serving cell of the at least one access network node.

### Supplementary Note B22

The method of any one of Supplementary Notes B18 to B21, wherein the handover decision parameters include a measurement event configuration for at least one UE of the at least one access network node and/or a handover trigger time upon reception of a measurement event.

### Supplementary Note B23

A user equipment, UE, comprising:
means for receiving, from an access network node, a measurement configuration for requesting information relating to expected data communication with the access network node; and
means for transmitting, to the access network node, a measurement report including the information, wherein
the information is used for outputting at least one parameter using a model for energy saving.

### Supplementary Note B24

An access network node comprising:
means for receiving measurement reports from one or more user equipments, UEs served by the access network node, each of the measurement reports including information relating to expected data communication with the access network node; and
means for sending, to a model training function, input data including the information which is used for outputting at least one parameter using a model for energy saving.

### Supplementary Note B25

A model training function of a communication network, the model training function comprising:
means for receiving, from at least one access network node, input data including information relating to expected data communication between a user equipment, UE, and the at least one access network node, for energy saving;
means for training a model using the input data; and
means for outputting a trained model to a model inference function of the communication network, for taking action for the energy saving.

### Supplementary Note B26

A model inference function of a communication network, the model inference function comprising:
means for receiving a model for outputting at least one parameter for energy saving;
means for receiving, from at least one of a plurality of access network nodes, input data including information relating to expected data communication between a user equipment, UE, and the at least one of the plurality of access network nodes; and
means for using the input data and the model to determine energy saving predictions or decisions for the at least one of the plurality of access network nodes.

This application is based upon and claims the benefit of priority from Great Britain Patent Application No. 2211641.2, filed on Aug. 9, 2022, the disclosure of which is incorporated herein in its entirety by reference.

### REFERENCE SIGNS LIST

1 mobile (cellular or wireless) telecommunication system
3 mobile device
5 base station
6 cell(s)
7 core network
8-1 Access and Mobility Management Function (AMF)
8-2 control plane function (CPF)
8-3 user plane function (UPF)
8-4 Session Management Function (SMF)
20 data network
31 transceiver circuit
33 antennas
35 user interface
37 controller
39 memory
41 operating system
43 communications control module
45 energy saving module
51 transceiver circuit
53 antennas
55 network interface
57 controller
59 memory
61 operating system
63 communications control module
65 energy saving module
71 transceiver circuit
75 network interface
77 controller
79 memory
81 operating system
83 communications control module
85 energy saving module
91 data collection function
93 model training function
95 model inference function
97 actor

What is claimed is:

1-26. (canceled)

27. A method performed by a model training function of a communication network, the method comprising:
receiving, from an access network node, input data including at least one of:
information relating to location of a user equipment (UE),
information relating to energy consumption of the access network node, for energy saving, or
traffic amount of each UE served by the access network node during a particular period of time;
training a model using the input data; and
outputting a trained model to a model inference function of the communication network.

28. A method performed by a model inference function of a communication network, the method comprising:
receiving a model for outputting at least one parameter for energy saving;
receiving, from at least one of a plurality of access network nodes, input data including at least one of:
information relating to location of a user equipment (UE),
information relating to energy consumption of an access network node, for energy saving, or
traffic amount of each UE served by the access network node during a particular period of time;
using the input data and the model to determine energy saving predictions or decisions for the access network node.

29. The method according to claim 28, wherein
the model inference function is part of a further access network node, and the method comprises:
receiving the input data from the access network node which is neighbour to the further access network node.

30. The method according to claim 28, further comprising:
using the energy saving predictions or decisions, the model and the input data to determine a command including information for a handover decision, for at least one access network node.

31. The method according to claim 30, wherein
the command indicates conditions for the UE to send a measurement report to the access network node.

32. The method according to claim 28, further comprising:
receiving, from the UE, a measurement report, and wherein
the using is performed by using the measurement report, the input data and the model to determine the at least one load prediction.

33. A model training function of a communication network, the model training function comprising:
at least one memory storing instructions; and
at least one processor configured to process the instructions to:
receive, from an access network node, input data including at least one of:
information relating to location of a user equipment (UE),
information relating to energy consumption of the access network node, for energy saving, or
traffic amount of each UE served by the access network node during a particular period of time;
train a model using the input data; and
output a trained model to a model inference function of the communication network.

34. A model inference function of a communication network, the model inference function comprising:
at least one memory storing instructions; and
at least one processor configured to process the instructions to:
receive a model for outputting at least one parameter for energy saving;
receive, from at least one of a plurality of access network nodes, input data including at least one of:
information relating to location of a user equipment (UE),
information relating to energy consumption of an access network node, for energy saving, or
traffic amount of each UE served by the access network node during a particular period of time; and
use the input data and the model to determine energy saving predictions or decisions for the access network node.
